(19) United States
(12) Patent Application Publication
(10) Pub. No.: US 2025/0173698 A1
(43) Pub. Date: May 29, 2025

(54) WIRELESS ENERGY TRANSACTION SYSTEMS AND METHODS

(71) Applicant: Oqab Dietrich Induction Inc., Kitchener (CA)

(72) Inventors: Haroon B. Oqab, Kitchener (CA); George B. Dietrich, Kitchener (CA)

(21) Appl. No.: 19/029,122

(22) Filed: Jan. 17, 2025

Related U.S. Application Data
(63) Continuation of application No. 17/635,737, filed on Feb. 16, 2022.
(60) Provisional application No. 62/888,178, filed on Aug. 16, 2019.

(51) Int. Cl. G06Q 20/32; G06Q 20/38; G06Q 40/04

(52) U.S. Cl. CPC G06Q 20/325; G06Q 20/389; G06Q 40/04

(57) ABSTRACT

Provided is a powered transaction system and method. The system includes a distributed blockchain application which facilitates wireless powered transactions between a buyer and a supplier, wherein the blockchain application includes at least one blockchain ledger, a wireless powered two-part blockchain currency, the two-part currency comprising a first currency and a second currency, a trust server which stores the two-part currency and fiat currency, and a first server, wherein the first server receives fiat currency from a buyer transaction device in a first transaction recorded on the at least one blockchain ledger and exchanges the fiat currency for two-part currency from the trust server, and wherein the first currency is provided to the buyer transaction device and the second currency is retained by the first server.

### TECHNICAL FIELD

The embodiments disclosed herein relate to powered transactions, and, in particular to systems, methods, and devices for wireless power, data and/or information transactions using blockchain.

### INTRODUCTION

Space-based and high-altitude solar power generation and transmission is a promising technology that can effectively meet increasing energy demands, and provides a safe, clean, and inexhaustible source of electric energy. Generating solar power in space may provide benefits versus generating solar power on Earth. These benefits may include, for example: collecting solar power directly from the Sun without atmospheric losses or obstructions like weather; collecting solar power for a longer period of time than on Earth or at all times depending on the location of power-generating satellites; always collecting solar power from multiple orbits; and the ability to direct power to and between receiving stations.

As space based solar power generation presents a potential global power solution, systems and methods for facilitating global space-based solar power transactions are needed.

### SUMMARY

In accordance with one aspect, the present application describes wireless powered transaction system. In another aspect of the system, includes a distributed blockchain application which facilitates wireless powered transactions between a buyer and a supplier, wherein the blockchain application includes at least one blockchain ledger and one or more servers to facilitate recording and transmission of the wireless powered transaction, wherein the servers mediate wireless powered transactions through the digital exchange of currency based on the creation and use of power.

In another aspect of the system, the system further includes a wireless powered two-part blockchain currency, the two-part currency comprising a first currency and a second currency.

In another aspect of the system, the one or more servers include a trust server which stores the two-part currency and fiat currency; and a first server, wherein the first server receives fiat currency from a buyer transaction device in a first transaction recorded on the at least one blockchain ledger and exchanges the fiat currency for two-part currency from the trust server, and wherein the first currency is provided to the buyer transaction device and the second currency is retained by the first server.

In another aspect of the system, of claim 1 further comprising at least one wireless power supplier device for receiving and storing power and from which at least one wireless power buyer device can receive power.

In another aspect of the system, the buyer exchanges the first currency for power from the at least one wireless power supplier in a second transaction recorded on the at least one blockchain ledger.

In another aspect of the system, the at least one wireless power supplier device and the first server combine the first currency and the second currency which is provided to the trust server in exchange for the fiat currency in a third transaction recorded on the at least one blockchain ledger, and the fiat currency is provided to the wireless power supplier device by the first server in a transaction recorded on the at least one blockchain ledger.

In another aspect of the system, the system further includes at least one wireless power transmitter for transmitting power.

In another aspect of the system, the system further includes a plurality of at least semi-autonomous aircraft, satellite, or ground-based devices configured as mobile transmitting and/or receiving power stations. A plurality of at least semi-autonomous aircraft, satellite, or ground-based devices are configured as a mobile transmitting and/or receiving power station, through which aircraft systems can navigate, maneuver, beam ride, and recharge from point to point. The plurality of at least semi-autonomous aircraft, satellite, or ground-based devices are configured to transmit and receive power and data to and from a land-based and/or water-based system to serve as power and data hubs, coupled to a plurality of tethers to further distribute power and/or data. The plurality of aircraft, satellite, and ground-based devices number at least 3, the aircraft, satellite, and ground-based devices are configured to transmit and receive quantum-entangled laser beams in order to exchange information, and the aircraft, satellite, and ground-based devices are arranged in an equilateral or near-equilateral triangle. Quantum entanglement may allow for secure and simultaneous communication among the devices so configured and arranged.

In another aspect of the system, the at least one power transmitter comprises at least one solar powered satellite.

In another aspect of the system, the system further includes a plurality of retrodirective antenna arrays for wireless power transfer by base stations for receiving and transmitting power and/or data.

In another aspect of the system, the at least one wireless power transmitter also transmits data.

In another aspect of the system, the at least one blockchain ledger includes at least one public blockchain and at least one private blockchain.

In another aspect, the present application describes a wireless powered transaction method. In another aspect of the method, includes transferring electromagnetic radiation from at least one solar powered satellite to at least one receiving station; and processing a purchasing of power from a supplier transaction device by the buyer transaction device.

In another aspect of the method, there is a plurality of at least three aircraft, satellite, or ground-based devices to act as receiving stations through which aircraft systems can navigate, maneuver, beam ride, and recharge from point to point. The plurality of at least semi-autonomous aircraft, satellite, or ground-based devices are configured to transmit and receive power and data to and from a land-based and/or water-based system to serve as power and data hubs, coupled to a plurality of tethers to further distribute power and/or data. The plurality of at least semi-autonomous aircraft systems, satellite systems, and ground-based devices number at least 3, the aircraft, satellite, and ground-based devices are configured to transmit and receive quantum-entangled laser beams in order to exchange information, and the aircraft, satellite, and ground-based devices are arranged in an equilateral or near-equilateral triangle. Quantum entanglement may allow for secure and simultaneous communication among the satellites so configured and arranged.

In another aspect of the method, the method further includes processing a purchase of a first currency of a two-part currency by the buyer transaction device, the two-part currency comprising the first currency and a second currency.

In another aspect of the method, purchasing includes: transferring fiat currency to a first server by the buyer transaction device; transferring the fiat currency to a trust server by the first server; receiving a two-part currency comprising a first currency and a second currency from the trust by the first entity; and transferring the first currency to the buyer transaction device by the first server.

In another aspect of the method, the method further includes recording a first transaction on a public blockchain, the first transaction comprising the transfer of the fiat currency to the first server by the buyer transaction device and the transfer of the first currency to the buyer transaction device by the first server.

In another aspect of the method, purchasing includes transferring the first currency to a supplier transaction device by the buyer transaction device; and transferring power to at least one wireless power buyer device from at least one wireless power supplier device.

In another aspect of the method purchasing includes recording a second transaction on a public blockchain, the second transaction comprising the transfer of the first currency to the supplier transaction device by the buyer transaction device and the transfer of the power to the at least one wireless power buyer device by the at least one wireless power supplier device.

In another aspect of the method purchasing includes combining the first currency and the second currency into the two-part currency by the supplier transaction device and the first server; and transferring the two-part currency to the trust server by the first server.

In another aspect of the method, purchasing includes recording a third transaction on public blockchain, the third transaction comprising the transfer of the two-part currency to the trust server by the first server; transferring the fiat currency to the first server by the trust server; and transferring the fiat currency to the supplier device by the first server.

In another aspect of the method, purchasing includes recording a fourth transaction on a private blockchain, the fourth transaction comprising the transfer of the fiat currency to the supplier transaction device by the first server.

In another aspect, the present application describes a wireless energy transfer system. The system includes a distributed blockchain application which facilitates a wireless energy transfer between a receiver and a transmitter, wherein the blockchain application includes at least one blockchain ledger; a first server, wherein the first server receives a request from the receiver for wireless energy, wherein the request is recorded on the at least one blockchain ledger, and wherein the server facilitates the transfer of wireless energy from the transmitter to the receiver.

In another aspect of the system, the system further includes at least one wireless power supplier device for receiving and storing power and from which at least one wireless power buyer device can receive power.

In another aspect of the system, the transmitter exchanges the first currency for power from the at least one wireless power supplier in a second transaction recorded on the at least one blockchain ledger.

In another aspect of the system, the system further includes a quantum secured blockchain network for wireless power transfer by a plurality of nodes for receiving and transmitting power, data and/or information.

In another aspect of the system, the system further includes a plurality of at least semi-autonomous aircraft, satellite, or ground-based devices configured as mobile transmitting and/or receiving power stations through which aircraft systems can navigate, maneuver, beam ride, and recharge from point to point. The plurality of at least semi-autonomous aircraft, satellite, or ground-based devices are configured to transmit and receive power and data to and from a land-based and/or water-based system to serve as power and data hubs, coupled to a plurality of tethers to further distribute power and/or data. The plurality of aircraft, satellite, and ground-based devices number at least 3, the aircraft, satellite, and ground-based devices are configured to transmit and receive quantum-entangled laser beams in order to exchange information, and the aircraft, satellite, and ground-based devices are arranged in an equilateral or near-equilateral triangle. Quantum entanglement may allow for secure and simultaneous communication among the satellites so configured and arranged.

In another aspect, the present application describes a wireless data transfer and communication system according to the principles of quantum entanglement. In an embodiment, quantum entanglement takes place among a group of satellites. That group is arranged in a formation as closely resembling an equilateral triangle as possible. A first satellite sends an entangled beam (e.g., a laser beam) of several bits to a second satellite. That second satellite sends the beam to a third satellite. That third satellite continues transmission back to that first satellite. More specifically, that first satellite polarizes a sequence to that second satellite. The second satellite receives a sequence with each bit flipped. The second satellite polarizes that sequence again and sends the sequence to that third satellite. The third satellite receives a signal with each bit flipped, which that third satellite polarizes and transmits to that first satellite. This system advantageously permits real-time communications at almost any distance using such triangular formations and entangled beams.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a block diagram of a generic computing device which may be used in accordance with an embodiment;

FIG. 2 is a schematic diagram of a network system including a blockchain for facilitating a wireless powered transaction, in accordance with an embodiment;

FIG. 3 is a block diagram of solar-based space power generation and transmission system, according to an embodiment;

FIG. 4 is a block diagram of a wireless powered transaction between a buyer and a power supplier, in accordance with an embodiment;

FIG. 5 is a block diagram of a wireless power or data transfer between a receiver and a supplier, in accordance with an embodiment;

FIG. 6 is a block diagram of a server in a computer system for wireless powered transactions, in accordance with an embodiment;

FIG. 7 is a flow chart of a method of creating and approving a wireless power contract using a blockchain, in accordance with an embodiment;

FIG. 8 is a block diagram of a business consortium for a wireless power transmission system, in accordance with an embodiment;

FIG. 9 is a flow chart of a method of requesting and receiving power/data from a transmitter by a receiver, in accordance with an embodiment;

FIG. 10A is a block diagram of a system for wireless data transfer and communication in accordance with an embodiment; and

FIG. 10B is a selection of the block diagram of FIG. 10A for more detailed viewing of the quantum entanglement paradigm, in accordance with an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud-based program or system, laptop, personal data assistance, cellular telephone, smartphone, or tablet device.

Each program is preferably implemented in a high-level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The following describes a system for establishing and maintaining a record of energy storage and use transactions for space-based energy. The transaction record is maintained by a blockchain system. The system utilizes new units of currency that are generated by the: production of energy, transmission of power, data and/or information, transfer of value and/or storage of energy, data and information.

The system may operate globally and on a distributed network, that is the system is not beholden to or under the control of a single country or specific group of countries.

The system includes a “transactional contract” which transactional contract establishes ownership of the transferred energy. The transferred energy may be used or stored by the recipient. The transactional contract may include a payment by the recipient to the energy transferor in exchange for the received energy.

The system is intended for energy that can be produced, used and stored on Earth and in Space. The system may facilitate the transfer of energy and/or data from point to point on Earth, be that ground to ground, ground to air, air to ground, ground to water, water to ground, air to air, air to water, water to air, or water to water. The system may facilitate the transfer of energy and/or data from Earth to space (spacecrafts, satellites), space to Earth, space to space, Earth to a celestial body (e.g. the Moon, Mars, asteroids), a celestial body to Earth, space to a celestial body, or a celestial body to space.

The value of energy is a key component of the global system of valuations. Accordingly, a currency based on production, use, and storage of usable energy may have a stronger base in international transactions than existing systems. Advantageously, using the systems and methods of the present disclosure, as more energy is produced, including new green energy, more currency may come into circulation. If currency is removed by use, a deficit may result which may encourage further production of energy.

The system can be used for transactions involving the transfer of energy in the form of wireless power, data, or information. Beneficially, the system can transfer this power, data, or information simultaneously as well as separately as the need arises.

Example use cases for the system may include: distributing power and/or data to mobile fleets (e.g. cars, boats, trains, airplanes, spacecrafts, drones, satellites, etc.), delivering power to internet of things (IoT) devices, collecting data from sensors, distributing power and/or data in smart cities, as well as the above mentioned embodiment of transactions for distributed power generation and information on Earth and in space.

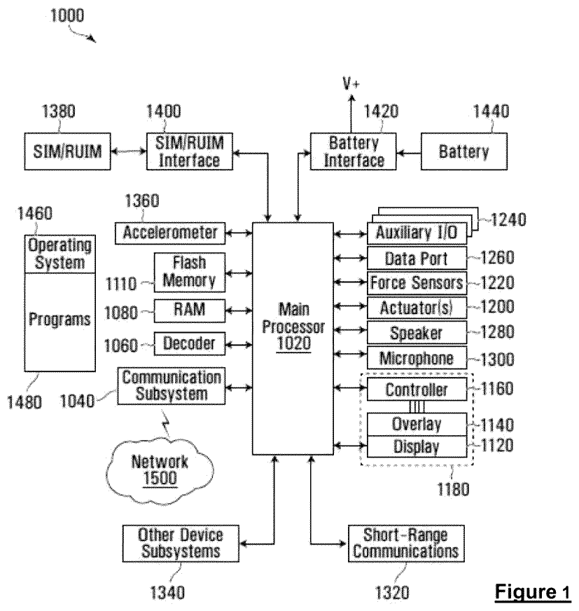

FIG. 1 shows a simplified block diagram of components of a device 1000, such as a mobile device or portable electronic device. The device 1000 includes multiple components such as a processor 1020 that controls the operations of the device 1000. Communication functions, including data communications, voice communications, or both may be performed through a communication subsystem 1040. Data received by the device 1000 may be decompressed and decrypted by a decoder 1060. The communication subsystem 1040 may receive messages from and send messages to a wireless network 1500.

The wireless network 1500 may be any type of wireless network, including, but not limited to, data-centric wireless networks, voice-centric wireless networks, and dual-mode networks that support both voice and data communications.

The device 1000 may be a battery-powered device and as shown includes a battery interface 1420 for receiving one or more rechargeable batteries 1440.

The processor 1020 also interacts with additional subsystems such as a Random Access Memory (RAM) 1080, a flash memory 1100, a display 1120 (e.g. with a touch-sensitive overlay 1140 connected to an electronic controller 1160 that together comprise a touch-sensitive display 1180), an actuator assembly 1200, one or more optional force sensors 1220, an auxiliary input/output (I/O) subsystem 1240, a data port 1260, a speaker 1280, a microphone 1300, short-range communications systems 1320 and other device subsystems 1340.

In some embodiments, user-interaction with the graphical user interface may be performed through the touch-sensitive overlay 1140. The processor 1020 may interact with the touch-sensitive overlay 1140 via the electronic controller 1160. Information, such as text, characters, symbols, images, icons, and other items that may be displayed or rendered on a portable electronic device generated by the processor 102 may be displayed on the touch-sensitive display 118. Furthermore, user-interaction may be performed in a mixed reality environment.

The processor 1020 may also interact with an accelerometer 1360 as shown in FIG. 1. The accelerometer 1360 may be utilized for detecting direction of gravitational forces or gravity-induced reaction forces.

To identify a subscriber for network access according to the present embodiment, the device 1000 may use a Subscriber Identity Module or a Removable User Identity Module (SIM/RUIM) card 1380 inserted into a SIM/RUIM interface 1400 for communication with a network (such as the wireless network 1500). Alternatively, user identification information may be programmed into the flash memory 1100 or performed using other techniques.

The device 1000 also includes an operating system 1460 and software components 1480 that are executed by the processor 1020 and which may be stored in a persistent data storage device such as the flash memory 1100. Additional applications may be loaded onto the device 1000 through the wireless network 1500, the auxiliary I/O subsystem 1240, the data port 1260, the short-range communications subsystem 1320, or any other suitable device subsystem 1340.

For example, in use, a received signal such as a text message, an e-mail message, web page download, or other data may be processed by the communication subsystem 1040 and input to the processor 1020. The processor 1020 then processes the received signal for output to the display 1120 or alternatively to the auxiliary I/O subsystem 1240. A subscriber may also compose data items, such as e-mail messages, for example, which may be transmitted over the wireless network 1500 through the communication subsystem 1040.

For voice communications, the overall operation of the portable electronic device 1000 may be similar. The speaker 1280 may output audible information converted from electrical signals, and the microphone 1300 may convert audible information into electrical signals for processing.

Device 1000 may be used by buyers, suppliers, receivers, or transmitters in wireless power transmission transactions or transfers.

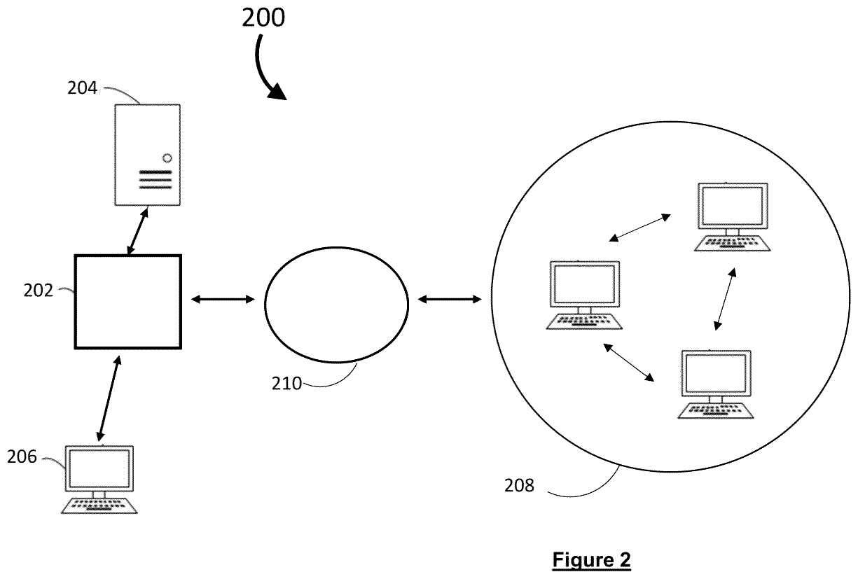

FIG. 2 shows a block diagram illustrating a wireless powered transaction system 200, in accordance with an embodiment, wherein wireless power is energy which is transmitted wirelessly and which is used to run a device. The system 200 includes a server platform 202 which communicates with a plurality of buyer transaction devices 204, a plurality of supplier transaction devices 206, and a network of blockchain computers 208 via a network 210.

Buyer transaction devices 204 and supplier transaction devices 206 may be a desktop computer, notebook computer, tablet, PDA, smartphone, or another computing device (similar to device 1000 from FIG. 1). Devices 204 and 206 may include a connection with server platform 202 such as a wired or wireless connection to the Internet. In some cases, server platform 202 may include multiple servers or other types of computers or telecommunication networks.

Devices 204 and 206 may include one or more of a memory, a secondary storage device, a processor, an input device, a display device, and an output device. Memory may include random access memory (RAM) or similar types of memory. Also, memory may store one or more applications for execution by processor. Applications may correspond with software modules comprising computer executable instructions to perform processing for the functions described below. Secondary storage device may include a hard disk drive, floppy disk drive, CD drive, DVD drive, Blu-ray drive, or other types of non-volatile data storage. Processor may execute applications, computer readable instructions or programs.

The applications, computer readable instructions or programs may be stored in memory or in secondary storage, or may be received from the Internet or other server platform 202. Input device may include any device for entering information into devices 204 and 206. For example, input device may be a keyboard, keypad, cursor-control device, touch-screen, camera, or microphone. Display device may include any type of device for presenting visual information. For example, display device may be a computer monitor, a flat-screen display, a projector or a display panel. Output device may include any type of device for presenting a hard copy of information, such as a printer for example. Output device may also include other types of output devices such as speakers, for example. In some cases, devices 204 and 206 may include multiple of any one or more of processors, applications, software modules, second storage devices, network connections, input devices, output devices, and display devices.

Although devices 204 and 206 are described with various components, one skilled in the art will appreciate that devices 204 and 206 may in some cases contain fewer, additional or different components. In addition, although aspects of an implementation of devices 204 and 206 may be described as being stored in memory, one skilled in the art will appreciate that these aspects can also be stored on or read from other types of computer program products or computer-readable media, such as secondary storage devices, including hard disks, floppy disks, CDs, or DVDs; a carrier wave from the Internet or other network; or other forms of RAM or ROM. The computer-readable media may include instructions for controlling devices 204 and 206 and/or processor to perform a particular method.

In the description that follows buyer transaction devices 204 and supplier transaction devices 206 are described performing certain acts. It will be appreciated that any one or more of these devices may perform an act automatically or in response to an interaction by a user of that device. That is, the user of the device may manipulate one or more input devices (e.g. a touchscreen, a mouse, a button, or a gesture-based interaction) causing the device to perform the described act. In many cases, this aspect may not be described below, but it will be understood.

As an example, it is described below that devices 204 and 206 may send information to server platform 202. For example, a buyer using buyer transaction device 204 may manipulate one or more input devices (e.g. a mouse and a keyboard) to interact with a user interface displayed on a display of buyer transaction device 204. Generally, the device may receive a user interface from server platform 202 (e.g. in the form of a webpage). Alternatively, or in addition, a user interface may be stored locally at a device (e.g. a cache of a webpage or a mobile application).

Server platform 202 may be configured to receive a plurality of information, from each of the plurality of buyer transaction devices 204 and supplier transaction devices 206. Generally, the information may comprise at least an identifier identifying the buyer or supplier. For example, the information may comprise one or more of a username, e-mail address, password, or social media handle.

In response to receiving information, server platform 202 may store the information in storage database. Generally, the storage database may be any suitable storage device such as a hard disk drive, a solid-state drive, a memory card, or a disk (e.g. CD, DVD, or Blu-ray etc.). Also, the storage database may be locally connected with server platform 202. In some cases, storage database may be located remotely from server platform 202 and accessible to server platform 202 across a network for example. In some cases, storage database may comprise one or more storage devices located at a networked cloud storage provider.

The buyer transaction device 204 may be associated with a buyer account. Similarly, the supplier transaction device 206 may be associated with a supplier account. Any suitable mechanism for associating a device with an account is expressly contemplated. In some cases, a device may be associated with an account by sending credentials (e.g. a cookie, login, or password etc.) to the server platform 202. The server platform 202 may verify the credentials (e.g. determine that the received password matches a password associated with the account). If a device is associated with an account, the server platform 202 may consider further acts by that device to be associated with that account.

The server platform 202 may be a purpose-built machine designed specifically for managing wireless energy transactions or transfer including the creation and recording thereof, and the generation and storage of data for facilitating said energy transactions or transfers.

Server 202 is connected to blockchain network 208 via network 210.

Server 202 sends a transaction request to blockchain network 208. The transaction request includes various information and data regarding a proposed transaction between a buyer, represented by buyer transaction device 204, and a supplier, represented by supplier device 206. A buyer may be any person or entity who consumes wireless energy or stores wireless energy for later use.

The blockchain network 208 receives the transaction request from the server 202 and approves or denies the transaction request.

The blockchain network 208 includes at least one distributed ledger. The distributed ledger may be a blockchain. Blockchain network 208 may include one or more blockchain ledgers. For example, the blockchain ledger may be stored on a plurality of computers in the blockchain network 208.

The blockchain ledger may be a private ledger or a public ledger. In an embodiment, the blockchain network 208 may store a plurality of blockchain ledgers. In such an embodiment, the blockchain ledgers may include a public ledger and a private ledger.

In an embodiment, the blockchain network 208 includes a decentralized and distributed blockchain. Other blockchain architectures may be employed in other embodiments.

Interactions between server 202, buyer device 204, and supplier device 206 may be vetted by the blockchain network 208 using the blockchain ledger.

All interactions, successful or otherwise, between devices 202, 204, 206 may be recorded on the blockchain ledger implemented by the blockchain network 208.

As described above, the system 200 is configured to manage wireless energy transactions involving the transfer of power or data. A transaction managed by the system 200 may include a transfer of power from a power supplier to a power buyer. The transfer of power from the power source (the device or location where the power is generated) to the supplier (any entity which supplies the power or data to an end user) or to a power storage device (any device where power is stored which is not the power source and does not directly supply power to an end user) may be recorded using servers and at least one blockchain ledger in a similar manner.

The blockchain network of system 200, and any other embodiments discussed herein, may be a quantum blockchain network, wherein any or all transactions or interactions are quantum secured. This blockchain would use quantum key encryption to maintain security, an improvement over non-quantum blockchains which are vulnerable to hacking.

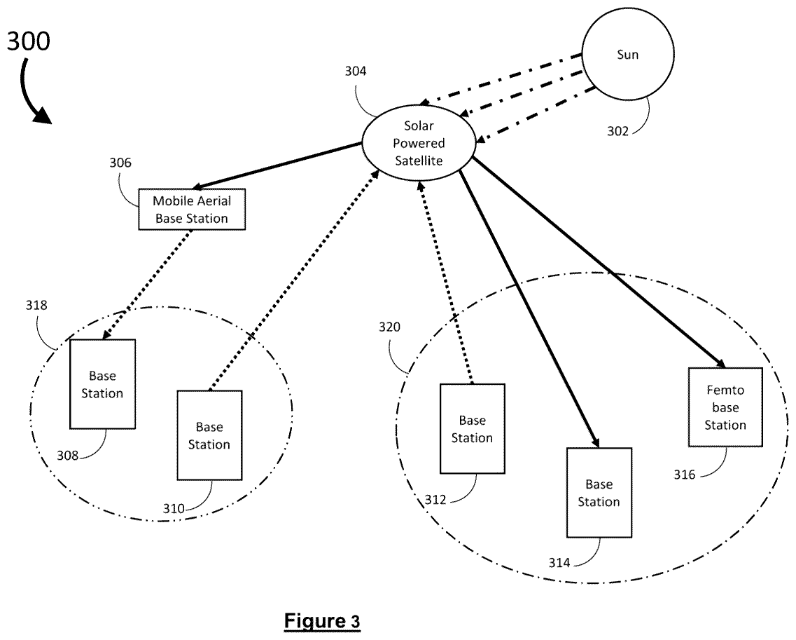

Referring now to FIG. 3, shown therein is a block diagram of a solar-based space power generation and transmission system 300, according to an embodiment. Solar-based space power generation and transmission system 300 converts solar energy to wireless power and then transmits that wireless power to earth for storage and use. This wireless power is the power that is being bought and sold in the transactions described in FIG. 3.

The solar-based space power generation and transmission system 300 includes a solar powered satellite 304.

In the embodiment of FIG. 3, there is a single solar powered satellite, however, it is to be understood that in other embodiments there may be an array of satellites which are generating and transmitting wireless power, which may be in any type of orbit, be located at any number of orbital heights, and be positioned at any location relative to one another and to Earth.

The solar powered satellite 304 receives solar energy from the Sun 302 and receives information from a plurality of base stations 306, 308, 310, 312, 314, and 316.

The plurality of base stations include a mobile aerial base station 306, base stations 308, 310, 312, 314, and a femto base station 316. These base stations are devices which can receive wireless power from solar powered satellite 304 and relay that power to other devices and/or store the wireless power. The base stations may receive the wireless power indirectly from solar powered satellite 304 through a receiver (not shown) which directly receives the wireless power from solar powered satellite 304.

In the embodiment of FIG. 3, the transmission of wireless power is discussed but it is to be understood that a solar powered satellite may transmit any electromagnetic energy and the energy may take the form of wireless power, data, or both.

Base stations 308 and 310 are located in a first region 318. Base stations 312, 314, and 316 are located in a second region 320.

Solar powered satellite 304 is powered by energy from the Sun 302. Solar powered satellite 304 converts energy from the Sun 302 into microwave energy. The microwave energy may represent a form of wireless power. In other embodiments, a solar powered satellite may convert solar energy into other forms of electromagnetic radiation.

Solar powered satellite 304 can transmit the converted solar energy (wireless power) to any one or more of mobile aerial base station 306, base station 308, base station 314, and femto base station 316. Solar powered satellite 304 may transmit wireless power to base stations or other devices on the ground or in the air. Solar powered satellite 304 may transmit wireless power to devices in space, such as other satellites or spacecrafts. Furthermore, solar powered satellite 304 may transmit wireless power to any one or more of mobile aerial base station 306, base station 308, base station 314, and femto base station 316. to devices through a relay system.

Solar powered satellite 304 is in an orbit which allows for a constant or almost constant supply of solar energy such as a geostationary orbit or sunsynchronous orbit. That is solar powered satellite 304 receives solar energy from an unobstructed Sun constantly or almost constantly. The ability of solar powered satellite 304 to collect solar energy almost constantly provides a significant benefit compared to solar energy technologies located on Earth. The solar powered satellite 304 can occupy multiple orbits to transmit wireless power to a plurality of mobile aerial base station 306, base station 308, base station 314, and femto base station 316.

Solar powered satellite 304 is shown transmitting power to first and second regions 318 and 320. Solar powered satellite 304 may be transmitting wireless power to the two regions 318 and 320 simultaneously or at separate times. Regions 318 and 320 be separated by a distance which does not allow simultaneous transmission of wireless power. Solar powered satellite 304 may change location in space relative to a location on Earth. This change of location may require satellite 304 to alter orbital locations (if the orbit is geostationary) or may simply require the passage of time (if the orbit is non-geostationary).

The ability to transmit to multiple base stations in different regions or different locations, such as ground and air, ground and space, and space and air, may be dependent on the number of transmission outputs solar powered satellite 304 has, where transmission output(s) are output(s) of satellite 304 which transmit or beam power to a destination. That is, solar powered satellite 304 may have multiple outputs which are capable of transmitting power such that solar powered satellite 304 can transmit multiple beams of power simultaneously. Solar powered satellite 304 may have the ability to digital beam form the position of the transmission outputs or use active and passive station keeping techniques to alter the entire satellite 304 with reference to the target base stations. That is transmission outputs may be steered relative to a main body of satellite 304 but satellite 304 may move relative to Earth, to another predefined input, or reference point, so that the path of transmission of power from a transmission output is altered, or transmission outputs may be articulating and move relative to the main body of satellite 304 so that the path of transmission of power from the transmission output moves relative to both satellite 304 and Earth.

The ability of satellite 304 to transmit to more than one base station at a time may be limited by the range of the satellite. For example, the satellite may only be able to transmit to multiple base stations that are located in regions that are within a certain distance of each other.

The ability of solar powered satellite 304 to transmit energy to different regions non-simultaneously may depend on the specific locations of the regions with respect to the position of the solar powered satellite 304 and its orbit.

The solar powered satellite 304 may also transmit data to base stations 306, 308, 310, 312, 314 and 316. The transmitted data may be transmitted along with energy to be used as wireless power. The transmitted data may be transmitted as microwave energy.

Base stations 306, 308, 310, 312, 314, and 316 may transmit the received data to one or more recipient devices. The recipient device may be a server, computer, a phone, a car, a plane, drones, a train, or the like. The data may be transmitted from the base station (306, 308, 310, 312, 314, or 316) to the receiving device in any suitable form.

The transmitted data may be integrated or combined with the microwave energy being transmitted by satellite 304 as wireless power.

The transmitted data may be filtered out of the same beam as the wireless power. The transmitted data may be within or entirely comprise a pilot beam, where the pilot beam is a beam sent from a transmitter to a receiver to establish and maintain a connection.

Satellite 304 may be configured to use certain frequencies of microwave energy to represent data and other frequencies for the wireless power energy. In some cases, the satellite may use fluctuations in frequency to transmit the data.

An example technology which currently receives power and data together is a chip on a contactless card. The chip receives both data and power through a radio frequency magnetic field.

Transmitting data as microwave energy from solar powered satellite 304 may allow for transmission of larger data files. For example, the larger files may be sent all at once instead of streaming the information or sending the information in smaller packets. The data may be encrypted more securely when transmitted in this manner, for example via quantum encryption.

The transmitted data may be transmitted along with the wireless power or alone. The transmitted data may have many uses. For example, the transmitted data could be used to recalibrate sensors on an array of satellites and/or sensors on the ground wherein solar powered satellite 304 is a point which all of the sensors in the array can reference to ensure they are as precise as possible.

The wireless power created by system 300 can be used immediately or stored in any device that is capable of storing the energy, such as a battery (e.g. car battery, home battery, phone battery, etc).

In other embodiments, the solar-based space power generation and transmission system 300 may include an array of satellites. The satellites in the satellite array may be at different orbital locations (e.g. geostationary orbit (GEO), medium Earth orbit (MEO), or low Earth orbit (LEO)). MEO and LEO are less limited than GEO in the space available for satellites and the regulation of the orbit and therefore provide more opportunity for creating an array of satellites.

Each satellite in the satellite array may be configured to produce and store energy, to only produce energy, or to only store energy received from other satellites. Storage of energy in space has the added benefit of ameliorating the loss of stored power which occurs when energy is stored on Earth. Energy may be stored indefinitely in Space without incurring major losses or by having losses made up by use of other power produced.

Each satellite in the satellite array may be configured to transfer energy and data and receive data.

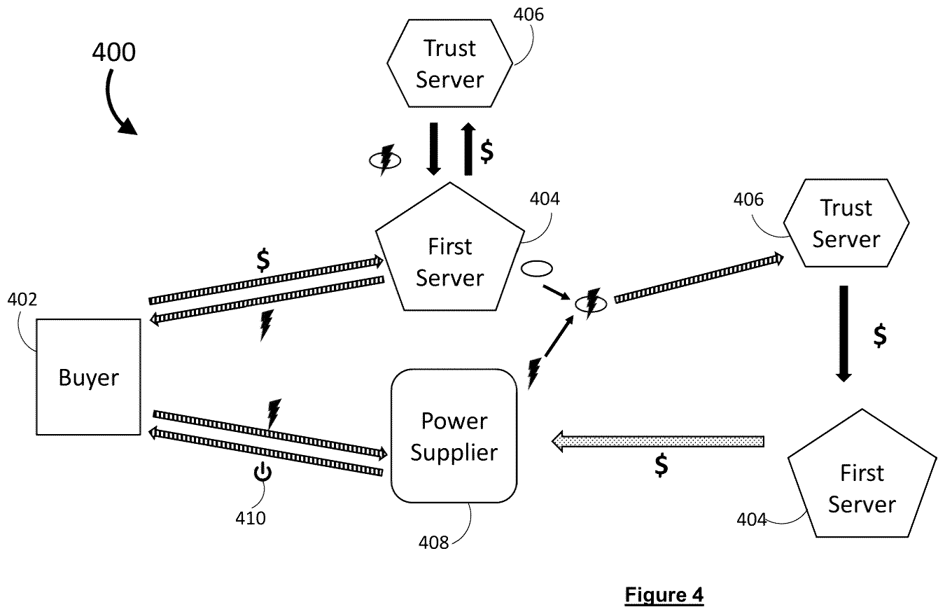

Referring now to FIG. 4, shown therein is a block diagram of a wireless powered transaction 400, in accordance with an embodiment. The transaction 400 may be implemented using the system 200 of FIG. 2.

The transaction 400 uses a two-part blockchain currency generated and stored by the system 100. The two-part blockchain currency includes a first currency and a second currency.

The two-part currency is referred to herein as a “voltierra”. The first currency is referred to herein as a “volt” and the second currency is referred to herein as a “tierra”. However, these names are merely examples and other names can be used for the two-part currency, first currency, or second currency.

In FIG. 4, volts are represented by a lightning bolt shape, tierras are represented by an oval, and the combined Volterra currency is represented by a lightning bolt on an oval. Fiat currency is represented by a dollar sign.

Transaction 400 includes a buyer 402, a first server 404, a trust server 406, and a power supplier 408. Buyer 402 may use a buyer device similar to buyer device 202 of FIG. 2. Power supplier 408 may use a supplier device similar to supplier device 206 of FIG. 2. First server 404 or trust server 406 may be similar to server 202 of FIG. 2. Generally, in transaction 400, buyer 402 wishes to purchase wireless power from power supplier 408 and engages with first server 404 and indirectly trust server 406 to facilitate the wireless powered transaction with power supplier 408. All aspects of the transaction are recorded on a blockchain.

The transaction 400 includes a plurality of currency exchanges between buyer 402, first server 404, trust server 406, and power supplier 408. The currency exchanges are represented by arrows. Striped arrows represent exchanges recorded on a public blockchain ledger. Dotted arrows represent exchanges recorded on a private blockchain ledger. Solid black arrows represent exchanges which do not include blockchain. Wireless power 410 is represented by a power symbol. Transaction 400 occurs as follows.

Buyer 402 purchases volts through first server 404 from trust server 406 through the following steps.

First server 404 receives fiat currency from buyer 402.

First server 404 exchanges the fiat currency for an equivalent amount of voltierras (volts+tierras) from trust server 406.

First server 404 provides the volts to buyer 402 while retaining the tierras.

Next, buyer 402 buys power from power supplier 408 using the volts through the following steps.

Buyer 402 provides volts to power supplier 408.

Power supplier 408 combines the volts with tierras from first server 404 (i.e. the tierras previously retained by the server 404) and the resulting voltierras are provided to trust server 406.

Trust server 406 sends fiat currency to first server 404. The amount of fiat currency is determined from the received voltierras. The first server 404 provides the fiat currency to power supplier 408.

Having received the fiat currency, power supplier 408 provides wireless power 410 to buyer 402.

An example of such a transaction may include a buyer and a supplier who initiate a transaction via QR codes using smartphones. The supplier may have a QR code on their smartphone which is scanned by the smartphone of the buyer. Upon scanning funds may be transferred from the buyer to the supplier and as above wireless power may then be transferred from the storage location of the supplier to the desired device of the buyer. The transaction is immediate and secure.

In the embodiment of FIG. 4, a proprietary two-part currency is used. In other embodiments, existing cryptocurrencies or fiat currency may be used.

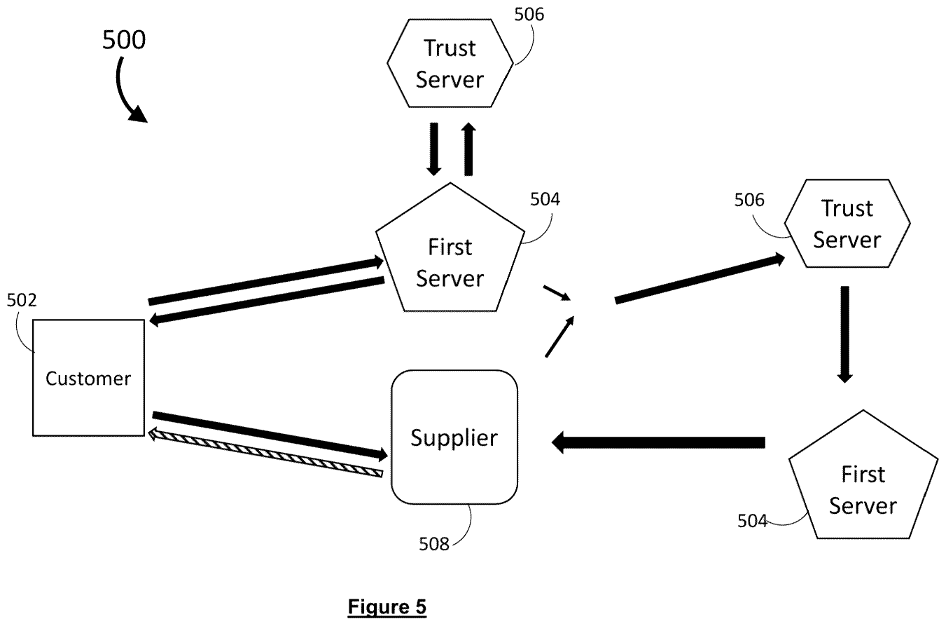

Referring now to FIG. 5, shown therein is a block diagram of a wireless energy transfer 500, in accordance with an embodiment. The wireless energy transfer 500 may be implemented using the system 200 of FIG. 2. Transfer 500 is similar to transaction 400 but does not include a two-part currency. Transfer 500 may also include the transfer of wireless power, data and/or information or any other type of wireless energy. Transfer 500 includes a customer 502, a first server 504, a trust server 506, and a supplier 508. Data which passes between customer 502, first server 504, trust server 506, and supplier 508 is represented by black arrows. This data may be requests, approvals, proof of approval, etc. The transfer of wireless energy in the form of power, data, and/or information from supplier 508 to customer 502 is represented by a striped arrow.

Customer 502 is similar to buyer 402 in FIG. 4. Customer 502 may acquire wireless energy from supplier 508 in exchange for something other than fiat currency, such as cryptocurrency, other data, etc.

Customer 502 sends a permission request to first server 504. The permission request requests permission to acquire wireless energy. This permission request may include non-fiat currency or data of some kind.

First server 504 interacts with trust server 506 to evaluate the permission request. Evaluating the permission request includes determining the eligibility of customer 502 to receive power/data/information based on the permission request.

The interactions in transfer 500 between customer 502, first server 504, and trust server 506 are represented by solid arrows. These interactions may be recorded, carried out, and permission may be granted on at least one blockchain.

Customer 502 sends a transfer request to supplier 508. The transfer request requests a wireless energy transfer with supplier 508.

Supplier 508 transmits the transfer request to the trust server 506. The first server 504 transmits the proof of permission to trust server 506. The request and permission may be sent to the trust server 506 together or separately. In cases where the request and the permission are sent together, the request may be received by the first server 504 and transmitted with the permission to the trust server 506.

The interaction including the transmission of the transfer request and the permission is recorded on the at least one blockchain.

Trust server 508 checks all relevant data (identity of buyer, identity of supplier, nature of request, etc.) and accepts or denies the requested transfer. Trust server 508 provides notification of acceptance or denial of the requested transfer to first server 504. This acceptance or denial is recorded on the at least one blockchain.

First server 504 transmits the acceptance or denial to supplier 508. If the transfer if accepted, supplier 508 transfers the wireless power to customer 502.

By implementing transfer 500 including the approval mechanism, the system can pre-approve a wireless energy receiver (e.g. customer 502) so that only pre-approved receivers can makes requests to suppliers.

In some cases, customer 502 may receive only wireless power from supplier 508. In some cases, customer 502 may receive only data or information from supplier 508. In some cases customer 502 may receive both wireless power and data from supplier 508.

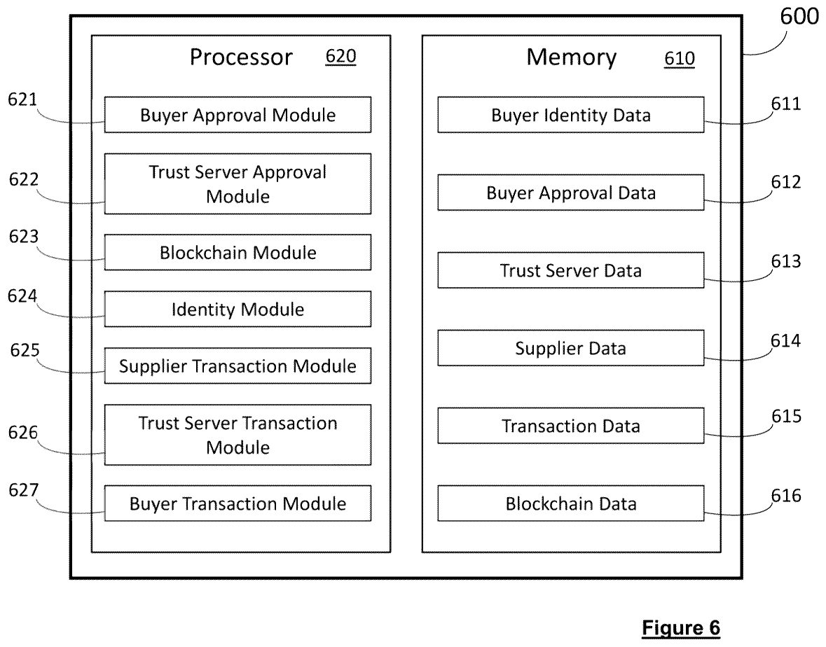

FIG. 6 is a block diagram of a server 600 in a computer system for wireless powered transactions, in accordance with an embodiment. Server 600 may be similar to server 202 of FIG. 2, server 404 of FIG. 4, and server 504 of FIG. 5.

Server 600 includes a memory 610 and a processor 620. Memory 610 may have instructions stored thereon which upon execution cause server 600 to perform the functions of methods or other actions discussed herein.

Memory 610 includes buyer identity data 611, buyer request data 612, approval data 613, trust server data 614, supplier data 615, transaction data 616, blockchain data 617, and currency data 618.

Processor 620 includes a buyer approval module 621, a trust server approval module 622, a blockchain module 623, an identity module 624, a buyer transaction module 625, a trust server transaction module 626, and a supplier transaction module 627.

While the term “buyer” is used in reference to FIG. 6 (e.g. buyer approval module 621), this term is not limited to persons or entities receiving power or data in exchange for currency. The buyer may also include any person or entity who is receiving power or data in exchange for something other than currency, such as data.

The computer system in which server 600 functions may be similar to the computer systems in FIG. 2, FIG. 4 and FIG. 5.

Server 600 is configured to perform various functions related to a wireless powered transaction (e.g. transaction 400 of FIG. 4, transaction 600 of FIG. 6) in which a buyer requests wireless power from a supplier.

Server 600 receives buyer identity data 611 and buyer approval data 612 from a buyer, such as via the buyer transaction device 104 of FIG. 2. Server 600 stores buyer identity data 611 and buyer approval data 612 in memory 610.

Buyer identity data 611 may be any data which identifies the buyer. For example, buyer identity data 611 may include personal identifiable information, financial information (e.g. bank account information, credit card information, etc.), or the like.

Buyer approval data 612 may be any data which can be used to approve the buyer as eligible to receive power/data. Buyer approval data 612 may include, for example, currency, proof of buyer having requisite funds or data to transfer, proof of location, proof of past successful transactions, or the like.

Data sent by the buyer may be sent from a computer, phone, or any other buyer device which is capable of sending such data.

Buyer approval module 621 sends buyer identity data 611 and buyer approval data 612 to a trust server (e.g. trust server 406 of FIG. 4 or trust server 506 of FIG. 5).

The trust server generates trust server data 613 (using buyer identity data 611 and buyer approval data 612). The trust server returns the trust server data 613 to the server 600. The trust server data 613 is provided as an input into a trust server approval module 622. Trust server data 613 includes information which either approves the buyer as a potential customer for a wireless powered transaction or rejects (i.e. does not approve) the buyer as a potential customer.

This interaction between server 600 and the trust server and the subsequent approval or rejection of the buyer may occur or be recorded on at least one blockchain. Blockchain module 623 either sends, receives, or sends and receives data to and/or from the at least one blockchain regarding the approval of the buyer. Blockchain data 616 regarding the at least one blockchain and/or received from the at least one blockchain is stored in memory 610.

In an embodiment in which a two-part currency is used for a wireless powered transaction, such as in transaction 400 of FIG. 4, the approval of the buyer may be a transaction in which the buyer receives a first part of a two-part currency in exchange for fiat currency. The buyer approval data 612 may be the fiat currency in electronic form. In these embodiments, the trust server stores the two-part currency and provides the two-part currency to server 600 in exchange for the fiat currency (buyer approval data 612) from the buyer. Server 600 provides the first part of the two-part currency to the buyer while retaining the second part of the two-part currency. In this embodiment, the trust server data 613 represents the two-part currency.

In an embodiment, the buyer approval may require confirming that the buyer's purported identity is true and/or that the buyer has the data or funds required for a wireless powered transaction.

Once the buyer has been approved and/or has received the first part of the two-part currency, the buyer sends a request to receive wireless power (or data) to a supplier. The request is represented as transaction data 615. Supplier data 614 is stored in memory 610 of server 600. Supplier data may be any identifying data about the supplier or may be data regarding the power/data the supplier currently has available. The supplier sends transaction data 615 to server 600. Transaction data 615 is stored in memory 610 of server 600.

Supplier transaction module 625 receives transaction data 615 from the supplier and checks the transaction details against buyer identity data 611 and supplier data 614 to confirm the identities of the parties.

Trust server transaction module 626 sends buyer identity data 611, trust server data 613, supplier data 614, and transaction data 614 to the trust server. The trust server checks all of the data against its own data regarding the buyer, supplier, and what transactions the buyer and supplier are eligible for. An eligibility determination is returned to server 600 as more trust server data 613 which is stored in memory 610.

Blockchain module 623 publishes the proposed transaction on a blockchain using buyer identity data 611, trust server data 613, supplier data 614, and blockchain data 616. The nodes of the blockchain network approve or deny the transaction until there is a consensus decision regarding the transaction. The consensus decision is returned to server 600 as additional blockchain data 616.

If the transaction is approved by the blockchain network, the buyer transaction module 627 sends an approval to the buyer and the supplier and the transaction proceeds.

If the transaction is denied by the blockchain network, the buyer transaction module 627 sends a rejection to the buyer and the supplier and the transaction does not occur.

Server 600 may facilitate the transfer of power or data from a supplier to a buyer/receiver. Server 600 may facilitate the transfer of power from a power source to a supplier (i.e. a power supplier) for storage.

In the embodiment of FIG. 6, server 600 facilitates a wireless powered transaction such as in FIG. 4, however in other embodiments a server similar to server 600 may facilitate the transfer of any form or wireless energy, including power, data, or other information, between two parties.

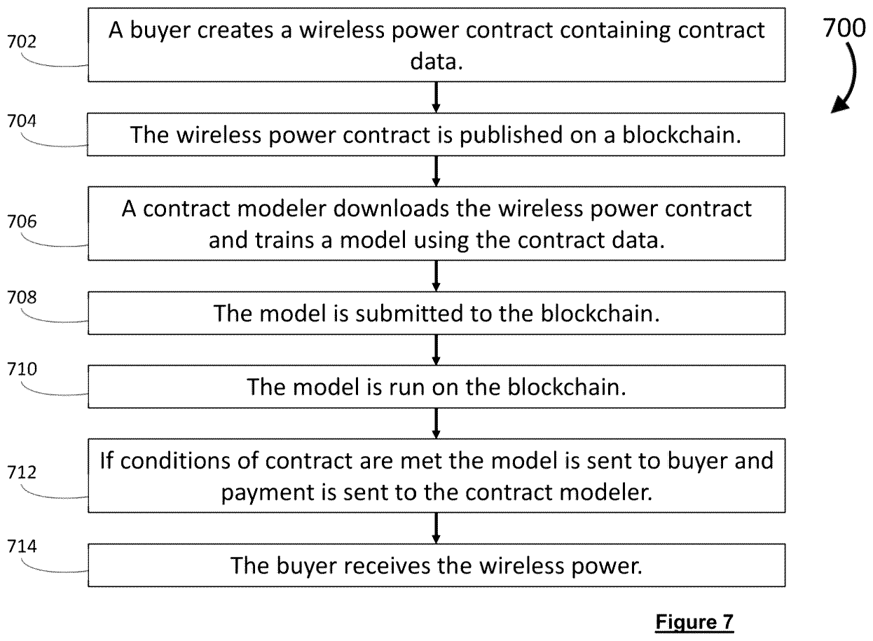

Referring now to FIG. 7, shown therein is a flow chart of a method 700 of creating and approving a wireless power contract using a blockchain. The method 700 may be performed by a wireless powered transaction system, such as system 100 of FIG. 2.

At 702, a buyer creates a wireless power contract. The wireless power contract includes data about the requested wireless powered transaction. The data may include a buyer identity, how the buyer wishes to purchase the wireless power (i.e., what type of currency or data they will provide in exchange for wireless power), an exact amount of wireless power requested, a date and time for transmitting the requested wireless power, a specific supplier, a device type for receiving the power, and any other relevant information.

At 704, the contract is published on a blockchain. The blockchain may be a distributed, decentralized blockchain.

At 706, a contract modeler downloads the contract data and trains a model.

The model is specific to the contract data provided by the buyer.

The contract modeler may be a human skilled in the task of training a model such as a machine learning engineer, software engineer, and/or subject matter expert etc. The contract modeler may be software (e.g. a neural network). The software may have been trained by a human skilled in the task, for example a machine learning engineer.

At 708, the model is submitted to the blockchain. The model may be submitted to the blockchain by the contract modeler.

At 710, the model is run on the blockchain. Running the model may include nodes on the blockchain network checking the model and either approving or rejecting the model. Checking the model may include generating a majority decision. The majority decision may represent decisions from all of the nodes on the blockchain network. The majority decision may determine whether the model is approved or rejected.

At 712, if all the conditions of the contract are met, the model is sent to the buyer. Payment is sent to the contract modeler.

At 714, the contract is fulfilled. The buyer receives the wireless power from the supplier. In an embodiment, the buyer may receive wireless data from the supplier instead of wireless power, or the buyer may receive both data and power from the supplier.

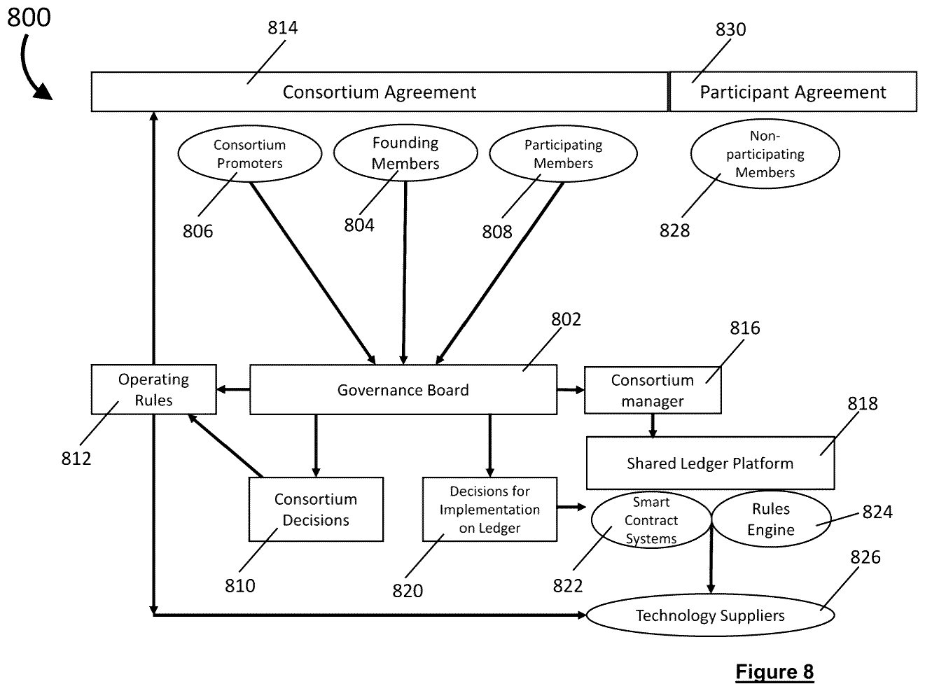

FIG. 8 is a block diagram of an exemplary business consortium 800 for a wireless power transmission system, according to an embodiment.

Consortium 800 represents one embodiment of a business model for a wireless power transmission system. Consortium 800 includes a governance board 802, founding members 804, consortium promoters 806, participating members 808, consortium decisions 810, operating rules 812, a consortium agreement 814, a consortium manager 816, a shared ledger platform 818, decisions for implementation on ledger 820, smart contract systems 822, a rules engine 824, technology suppliers 826, non-participating members 828, and a participant agreement 830. Consortium 800 functions as follows.

Governance board 802 includes a plurality of members who make decisions regarding how consortium 800 is run. Governance board 802 may include members of three groups who have a vested interest in consortium 700: founding members 804, consortium promoters 806, and participating members 808. Governance board 802 may also include members who are not from one of the three groups: 804, 806, 808.

Founding members 804 are the members of the consortium who were part of the business model from its initial founding. Consortium promoters 806 are members who are not directly involved in founding consortium 800 and who may not directly participate in the business model but are investors or otherwise promoters of consortium 800. Participating members 808 are members who participate in the consortium but were not yet members at the founding of the business model. Participating members 808 may have less privileges within consortium 800 than founding members 803.

Governance board 802 is responsible for consortium decisions 810. These decisions 810 may be any decision that has an effect on the way the business model and the consortium 800 are run. The consortium decisions 810 may affect operating rules 812 of the consortium 800. The operating rules 812 are included in consortium agreement 814. All members of the consortium 800 (e.g. founding members 804, consortium promoters 806, and participating members 808) agree to the consortium agreement 814 and thus agree to adhere to the operating rules 812. The operating rules 812 must also be followed by technology suppliers 826.

The consortium 800 uses blockchain technology and systems to implement wireless powered transactions.

Consortium manager 816 manages the operation of the consortium 800 at the level of shared ledger platform 818 and does so in direct response to decisions and information from governance board 802. Consortium manager 816 may be at least one human who implements decisions or consortium manager 816 may be a computer program designed to implement decisions.

Shared ledger platform 818 includes at least one blockchain ledger for recording and storing the transactions. The blockchain ledger may be a public distributed ledger or a private distributed ledger. The blockchain system may include a plurality of ledgers. In embodiments using a plurality of ledgers, the ledgers may be public, private, or both.

Governance board 802 also makes decisions for implementation of ledger 820. Decision for implementation on ledger 820 are implemented in smart contract systems 822 of the blockchain as well as rules engine 824 of the blockchain.

Smart contract systems 822 and rules engine 824 are computer components of the blockchain system and may include servers, computers, and other types of telecommunications devices as well as artificial intelligence or machine learning components.

Together shared ledger platform 818, smart contract systems 822, and rules engine 824 determine which transactions are allowed to be completed. Technology supplier 826, which may include suppliers of wireless power to consortium customers, are informed of the decision to allow a transaction to occur once the transaction has been approved by the blockchain.

In addition to members discussed above, non-participating members may join the consortium by signing participant agreement 830 to become participating members 808.

Consortium 800 may be distributed globally. Founding members 804, consortium promoters 806, participating members 808, non-participating members 828, technology suppliers 826, and nodes within shared ledger platform 818 may be located anywhere. The lack of local control of consortium 800 may advantageously promote a global system for green energy consumption wherein the cost of wireless power is not determined by a monopoly.

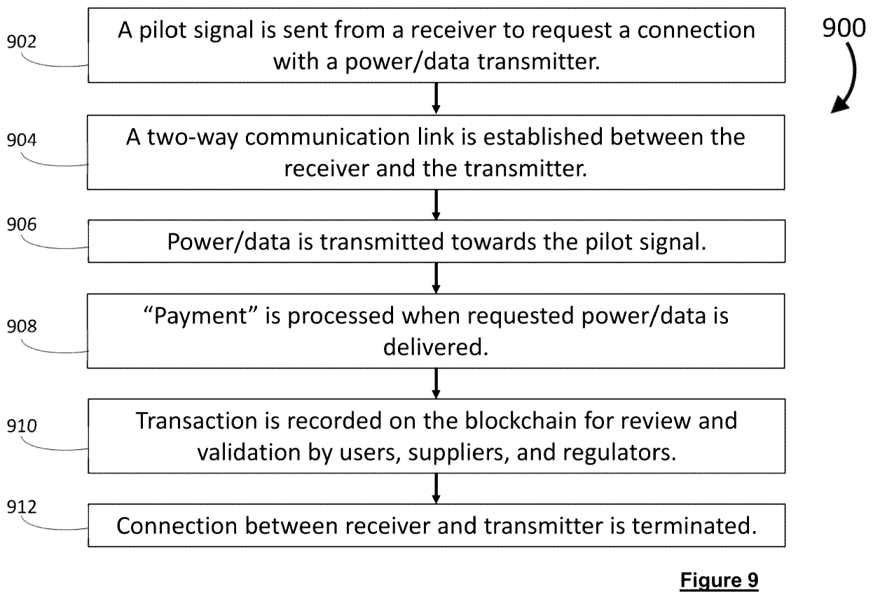

Referring now to FIG. 9, shown therein is a flow chart of a method 900 of requesting and receiving power/data from a transmitter by a receiver. Method 900 describes the steps required for a buyer or receiver of wireless power, such as buyer 402 from FIG. 4 or customer 502 from FIG. 5 to receive power/data from a supplier such as power supplier 408 of FIG. 4 or supplier 508 of FIG. 5) or transmitter.

At 902, a pilot signal is sent by a receiver. The pilot signal requests a connection with a transmitter. The transmitter is configured to transmit power, data, or power and data. The pilot signal may contain identifying information for the receiver.

At 904, a two-way communication link is established between the receiver and the transmitter.

The two-way communication link may be established if the transmitter recognizes and approves the receiver based on any identifying information or specific request information that has been sent to the transmitter.

At 906, the power and/or data requested by the receiver is sent to the receiver from the transmitter. The pilot signal is used as a location beacon. The power and/or data may be sent from the transmitter to the receiver on the reverse path of the pilot signal to ensure that the power and/or data is received by the receiver. The connection between the receiver and transmitter may be maintained for at least as long as necessary for the requested power and/or data to be transferred from the transmitter to the receiver.

At 908, a “payment” is processed. The payment is processed from the receiver to the transmitter once the requested power and/or data has been delivered to the receiver. The payment may be in the form of fiat currency, a two-part currency (e.g. two-part currency “Voltierra” of FIG. 4), or another form of cryptocurrency (e.g. an established cryptocurrency like Bitcoin). The payment may be in some other form of data transferred from the receiver to the transmitter in exchange for the received power and/or data. For example, the transfer of power and/or data may be from a power source to a storage point and therefore no exchange of currency may occur because the power/data is not being transferred to a customer.

At 910, the transaction between the receiver and the transmitter is recorded on at least one blockchain ledger.

The blockchain ledger may be a public ledger or a private ledger. Users of the blockchain ledger, suppliers of power and/or data, and regulators of the blockchain or the wireless power/data consortium (as in FIG. 8) can review and validate the transaction to ensure that the transmission of power and/or data occurred as expected. Even when the transaction which is occurring does not include a customer but simply includes the movement of power from, for example, a power source to a storage point, or a storage point to another storage point the transfer of power/data is recorded on the at least one blockchain ledger.

At 912, once the correct transfer of power and/or data has been confirmed the connection between the receiver and the transmitter is terminated.

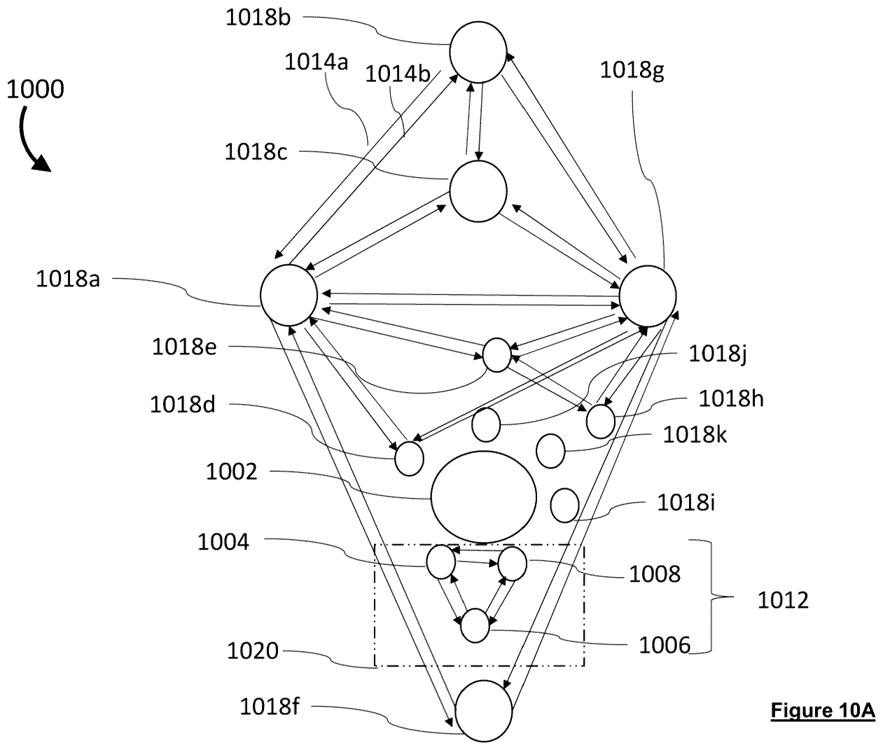

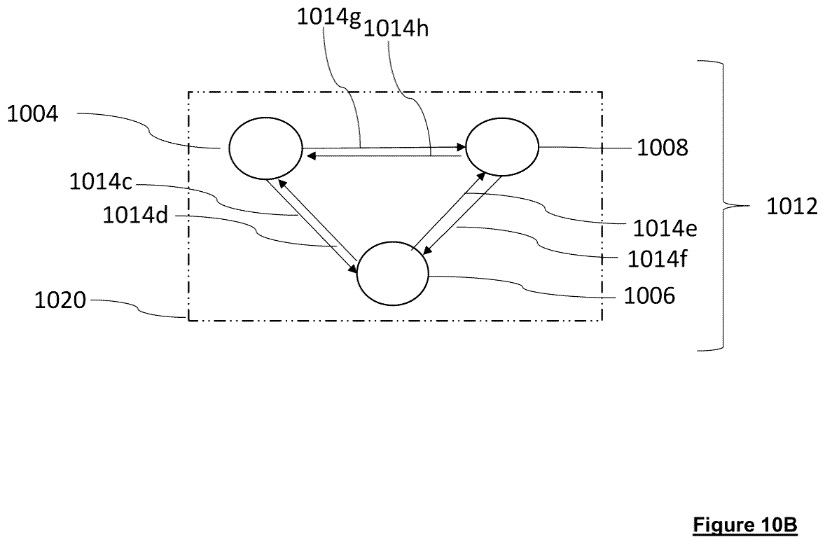

Referring now to FIG. 10A, shown therein is a block diagram of a wireless data transfer and communication system 1000 in accordance with an embodiment. Referring also to FIG. 10B, shown therein is a selection 1020 of the block diagram of FIG. 10A. The selection 1020 in FIG. 10B shows the desired triangular arrangement of three satellites 1004, 1006, and 1008 at such a scale as to permit identification of each of the entangled beams 1014c, 1014d, 1014e, etc. being transmitted among those satellites.

System 1000 is according to the principles of quantum entanglement among several satellites 1018a, 1018b, etc. Each group of satellites 1018a, 1018b, etc. is arranged in a formation as closely resembling an equilateral triangle as possible.

The system 1000 further includes a plurality of at least semi-autonomous aircraft, satellite, or ground-based devices 1018a, 1018b, etc. configured as mobile transmitting and/or receiving power stations. A plurality of at least semi-autonomous aircraft, satellite, or ground-based devices are configured as a mobile transmitting and/or receiving power station, through which aircraft systems can navigate, maneuver, beam ride, and recharge from point to point. The plurality of at least semi-autonomous aircraft, satellite, or ground-based devices 1018a, 1018b, etc. are configured to transmit and receive power and data to and from a land-based and/or water-based system such as 1018k or 1018i to serve as power and data hubs, coupled to a plurality of tethers, e.g., 1014a, 1014b, etc. to further distribute power and/or data. The plurality of aircraft, satellite, and ground-based devices 1018a, 1018b, etc. number at least 3, the aircraft, satellite, and ground-based devices 1018a, 1018b, etc. are configured to transmit and receive quantum-entangled laser beams 1014a, 1014b, etc. in order to exchange information, and the aircraft, satellite, and ground-based devices 1018a, 1018b, etc. are arranged in an equilateral or near-equilateral triangle as in group 1012. Quantum entanglement may allow for secure and simultaneous communication among the devices so configured and arranged.

Within selection 1020, satellites 1004, 1006, and 1008 constitute a group of satellites 1012. Group 1012 is arranged in a formation as closely resembling an equilateral triangle as possible. Group 1012 is located near planet Earth 1002. Group 1012 consists of satellite 1004 within the air, satellite 1006 located in outer space, and satellite 1008 located on the ground. These satellites are arranged in the shape of an equilateral triangle. The shape of an equilateral triangle permits the continuous array of satellites, aircraft, and ground-based devices, whether located as shown or further into outer space or on planetary or celestial bodies, to effect near-simultaneous communications via the ability to switch between nodes. Using quantum entanglement, this communication paradigm is secure and simultaneous through the transmission among the satellites of entangled beams 1014c, 1014d, 1014e, etc.

Satellite 1006 receives an entangled beam 1014c from satellite 1004. The beam 1014c contains a sequence, for example 100011. Satellite 1006 then polarizes the sequence 100011 to send as information 011100. Satellite 1006 polarizes sequence 100011 by varying polarization. Satellite 1006 varies polarization continuously until a connection is determined. The step of varying polarization until a connection is determined is performed at all six points of connection as shown by the three pairs of beams 1014c, 1014d; 1014e, 1014f; and 1014g, 1014h. Satellite 1008 immediately receives the signal 1014e, for example 011100, from satellite 1006 as an inverse-polarized beam. Satellite 1008 polarizes the signal, for example 100011, it receives from satellite 1004 via beam 1014g. Satellite 1006 receives the polarized beam 1014f, for example 011100, in inverse fashion. Through the operation of the satellites in the formation of an equilateral triangle in group 1012, all three satellites 1004, 1006, and 1008 can have the same information. Satellites 1004, 1006, and 1008 achieve the same information through determining the source of a beam 1014 and inverting that beam as necessary. A receiving satellite 1004, 1006, or 1008 can also reply in reverse order. All these operations may be performed regardless of the actual distance between satellites.

In another aspect, the present application describes a set of nodes, e.g., satellites, either autonomous or semi-autonomous, that may be deployed in the field and use a system to communicate with each other. Using quantum entanglement, the system may allow for entangled, secure, and simultaneous communication. In order for this communication to be simultaneous, the nodes must be arranged in equilateral triangles of any size. The system may switch between nodes as nodes move around and elongate the sides of the respective triangles. Using this method, a continuous array of spacecraft and locations (e.g., asteroids, moons) may allow for near-simultaneous communication through the ability to switch between nodes. The same connection may be used for all nodes for security when simultaneity is not needed.

In another aspect, the set of nodes consists of three satellites arranged in a triangle. Each satellite messages the other satellites through laser beams entangled through quantum entanglement. As an example of the entangled communications possible in the present aspect, the first satellite polarizes a sequence 100011 to the third satellite. The third satellite receives a sequence corresponding to an inversion 011100 of that sequence sent by the first satellite. The third satellite re-polarizes the sequence and transmits this sequence 100011 to the second satellite. The second satellite receives a re-polarized sequence 011100, polarizes this sequence, and sends sequence 100011 to the first satellite. As the laser beams are quantum-entangled, the triangle may be of any size.

Latency may be a serious concern. The ability to create real-time communications at almost any distance using triangles, or higher-order geometry based on the same concept. Creating such real-time communications at almost any distance requires the beams be in the appropriate place and the triangle be as close to equilateral as possible. Such an approach allows any moving-laser-connected group of systems to operate as one system as though it were on a single worktable. Such a feature is important for a system located in outer space.

As a further example of the entangled communications possible in the present aspect, a first satellite receives an entangled beam from a second satellite. The second satellite polarizes a sequence, e.g., binary signal 010, to send as information. The second satellite polarizes the sequence by varying polarization and doing so continuously until a connection is determined. This process is performed with respect to all six points of connection among three satellites. The polarized sequence is then immediately received from the second satellite at a third satellite as reverse-polarized sequence 101. The third satellite then polarizes the entangled beam received from the first satellite as 010. This latter entangled beam is then received at the second satellite as 101. This aspect permits all three nodes to have the same information through simply knowing the source of a transmission and inverting that transmission as necessary. The nodes can also reply in the reverse order. The present example is possible regardless of the distance between the nodes.

In another aspect, the set of nodes may be a swarm of drones and/or airships, provided that swarm of drones and/or airships numbers a multiple of three.

In an embodiment, a review and validation on the at least one blockchain ledger of the eligibility of the proposed transaction between the receiver and the transmitter may occur before the transfer of power/data may begin. Only if the transaction is deemed valid and possible will the transfer occur.

In an embodiment, the transmitter of power and/or data may be the original power source (i.e. where the power is generated) or may be a transmitter where the power/data is stored (as opposed to generated).

Where the transmitter is a power storage device, the power storage device may, at times, also function as a receiver of power/data from a power source. The power source may be a space-based satellite, spacecraft, or other device that can create power from the Sun and convert that power to a usable energy or data source within the electromagnetic spectrum. For example, a satellite may be similar to solar powered satellite 304 from FIG. 3. The transmitted power (or data) may be microwave energy. In other embodiment, the transmitted power may include wavelengths of energy other than microwaves.

Where the power source is located in space, the power source may transmit the power/data to multiple power storage devices in a distributed network. The distributed network may be located in space, on celestial bodies, or on Earth, either in the air, on the ground, or in water.

A power storage transmitter may be a satellite or spacecraft in space, a storage device on celestial bodies, or a storage device on Earth.

The power storage device may include an array of power storage devices. The array may include, for example, drones positioned globally or over a large area.

The power storage devices may be mobile (e.g., automobiles, boats, planes, etc.). The power storage devices may be fixed and stationary (e.g. power stations, energy banks within buildings or smart cities, etc.). The power storage devices may be a hybrid or tethered system wherein a “stationary” power source is not kept in a fixed location but rather is mobile, or wherein a mobile power source is kept in a fixed location.

In an embodiment, the receiver is also a transmitter. The power and/or data may be transferred throughout an array of receiver/transmitters. The receiver/transmitters may be in various 2- or 3-dimensional topologies. Each receiver/transmitter may be a node in a network. The receiver/transmitter receives power/data from at least one power source or at least one other node and/or transmits power/data to at least one other node. This embodiment may allow for an entire array of nodes (e.g. drones) that may be spread out over a large area to be powered from a single power source. This embodiment may also allow for a single power source to power multiple systems from a single location. Furthermore, this embodiment may allow for multiple power sources to power a single location.

In an embodiment, network security is established based on the laws of quantum physics.

In an embodiment, the network uses quantum key distribution (QKD). For authentication, QKD generates a secret key between two parties connected by a quantum channel and a public classical channel for transmitting quantum states and for post-processing procedures, respectively. The quantum secured blockchain uses a multi layered network for a plurality of nodes for receiving and transmitting power, data and/or information.

While the above description provides examples of one or more apparatus, methods, or systems, it will be appreciated that other apparatus, methods, or systems may be within the scope of the claims as interpreted by one of skill in the art.

1. A wireless powered transaction system, the system comprising:
a distributed blockchain application which facilitates wireless powered transactions between a buyer and a supplier, wherein the blockchain application includes at least one blockchain ledger;
one or more servers to facilitate recording and transmission of the wireless powered transaction, wherein the servers mediate wireless powered transactions through the digital exchange of currency based on the creation and use of power.

2. The system of claim 1 further comprising a wireless power two-part blockchain currency, the two-part currency comprising a first currency and a second currency.

3. The system of claim 2 wherein the one or more servers include:
a trust server which stores the two-part currency and fiat currency; and
a first server, wherein the first server receives fiat currency from a buyer transaction device in a first transaction recorded on the at least one blockchain ledger and exchanges the fiat currency for two-part currency from the trust server, and wherein the first currency is provided to the buyer transaction device and the second currency is retained by the first server.

4. The system of claim 3 further comprising at least one wireless power supplier device for receiving and storing power and from which at least one wireless power buyer device can receive power.

5. The system of claim 4, wherein the buyer exchanges the first currency for power from the at least one wireless power supplier in a second transaction recorded on the at least one blockchain ledger.

6. The system of claim 4, wherein the at least one wireless power supplier device and the first server combine the first currency and the second currency which is provided to the trust server in exchange for the fiat currency in a third transaction recorded on the at least one blockchain ledger, and the fiat currency is provided to the wireless power supplier device by the first server in a transaction recorded on the at least one blockchain ledger, and the system further comprises at least one wireless power transmitter for transmitting power.

7. The system of claim 6 further comprising:
a plurality of semi-autonomous devices configured as mobile transmitting or receiving power stations through which aircraft systems can navigate, maneuver, beam ride, and recharge from point to point;
wherein the plurality of semi-autonomous devices number at least 3, the semi-autonomous devices are configured to transmit and receive quantum-entangled laser beams in order to exchange information, and the semi-autonomous devices are arranged in an equilateral or near-equilateral triangle and quantum entanglement allows for secure and simultaneous communication among the devices; and
wherein the semi-autonomous devices are configured to transmit and receive power and data to and from a land-based or water-based system to serve as power and data hubs, coupled to a plurality of tethers to further distribute power and/or data.

8. The system of claim 6 wherein the at least one power transmitter comprises at least one solar powered satellite and wherein the at least one wireless power transmitter also transmits data and/or information.

9. The system of claim 3 further comprising a plurality of retrodirective antenna arrays for wireless power transfer by base stations for receiving and transmitting power, data and/or information.

10. A wireless powered transaction method, the method comprising:
transferring electromagnetic radiation from at least one solar powered satellite to at least one receiving station; and
processing a purchasing of power from a supplier transaction device by the buyer transaction device.

11. The method of claim 10, wherein there is:
a plurality of aircraft, satellite, and ground-based devices configured as a mobile transmitting and/or receiving power station, through which aircraft systems can navigate, maneuver, beam ride, and recharge from point to point
wherein the plurality of aircraft systems, satellite systems, and ground-based devices number at least 3, the aircraft, satellite, and ground-based devices are configured to transmit and receive quantum-entangled laser beams in order to exchange information, and the aircraft, satellite, and ground-based devices are arranged in an equilateral or near-equilateral triangle so that quantum entanglement will allow for secure and simultaneous communication among the satellites so configured and arranged; and
wherein the plurality of aircraft, satellite, and ground-based devices are configured to transmit and receive power and data to and from a land-based and/or water-based system to serve as power and data hubs, coupled to a plurality of tethers to further distribute power and/or data.

12. The method of claim 10, wherein processing a purchasing of power includes processing a purchase of a first currency of a two-part currency by the buyer transaction device, the two-part currency comprising the first currency and a second currency.

13. The method of claim 12, wherein purchasing includes:
transferring fiat currency to a first server by the buyer transaction device;
transferring the fiat currency to a trust server by the first server;
receiving a two-part currency comprising a first currency and a second currency from the trust by the first entity; and
transferring the first currency to the buyer transaction device by the first server.

14. The method of claim 13 further comprising recording a first transaction on a public blockchain, the first transaction comprising the transfer of the fiat currency to the first server by the buyer transaction device and the transfer of the first currency to the buyer transaction device by the first server.

15. The method of claim 12, wherein purchasing includes:
transferring the first currency to a supplier transaction device by the buyer transaction device; and
transferring power to at least one wireless power buyer device from at least one wireless power supplier device.

16. The method of claim 15, wherein purchasing includes recording a second transaction on a public blockchain, the second transaction comprising the transfer of the first currency to the supplier transaction device by the buyer transaction device and the transfer of the power to the at least one wireless power buyer device by the at least one wireless power supplier device.

17. The method of claim 16, wherein purchasing includes:
combining the first currency and the second currency into the two-part currency by the supplier transaction device and the first server;
transferring the two-part currency to the trust server by the first server;
recording a third transaction on public blockchain, the third transaction comprising the transfer of the two-part currency to the trust server by the first server;
transferring the fiat currency to the first server by the trust server;
transferring the fiat currency to the supplier device by the first server; and
recording a fourth transaction on a private blockchain, the fourth transaction comprising the transfer of the fiat currency to the supplier transaction device by the first server.

18. A wireless energy transfer system, the system comprising:
a distributed blockchain application which facilitates a wireless energy transfer between a receiver and a transmitter, wherein the blockchain application includes at least one blockchain ledger;
a first server, wherein the first server receives a request from the receiver for wireless energy, wherein the request is recorded on the at least one blockchain ledger, and wherein the server facilitates the transfer of wireless energy from the transmitter to the receiver; and
at least one wireless power supplier device for receiving and storing power and from which at least one wireless power buyer device can receive power.

19. The system of claim 18 further comprising a quantum secured blockchain network for wireless power transfer by a plurality of nodes for receiving and transmitting power, data and/or information.

20. The system of claim 19 further comprising:
a plurality of aircraft, satellite, and ground-based devices configured as a mobile transmitting and/or receiving power station, through which aircraft systems can navigate, maneuver, beam ride, and recharge from point to point;
wherein the plurality of aircraft, satellite, and ground-based devices number at least 3, the aircraft, satellite, and ground-based devices are configured to transmit and receive quantum-entangled laser beams in order to exchange information, and the aircraft, satellite, and ground-based devices are arranged in an equilateral or near-equilateral triangle so that quantum entanglement will allow for secure and simultaneous communication among the satellites so configured and arranged; and
wherein the plurality of aircraft, satellite, and ground-based devices are configured to transmit and receive power and data to and from a land-based and/or water-based system to serve as power and data hubs, coupled to a plurality of tethers to further distribute power and/or data.
